(19) United States
(12) Patent Application Publication
(10) Pub. No.: US 2004/0074964 A1
(43) Pub. Date: Apr. 22, 2004

(54) Multi-modal items tracking heritage

(76) Inventor: Ingrid Falkenrich-Wesche, Hockenheim (DE)

Correspondence Address: Ingrid Falkenrich-Wesche, Wasserturmallee 47, Hockenheim, 68766, DE

(21) Appl. No.: 10/277,235

(22) Filed: Oct. 22, 2002

(51) Int. Cl. G06F 17/60

(52) U.S. Cl. 235/385

(57) ABSTRACT

Multi-modal items tracking heritage based on radio frequency tags allows the seamless tracking of all goods processing in the supply chain. By reference of all source information at every level of the chain, detailed monitoring is enabled at a minimum additional effort in the execution. Multi-modal readers allow for the coexistence of the barcode identification with the advanced RFID technology. With the new heritage system, information is readily available from the web at any detail level preserved. This ability supports at the same time:

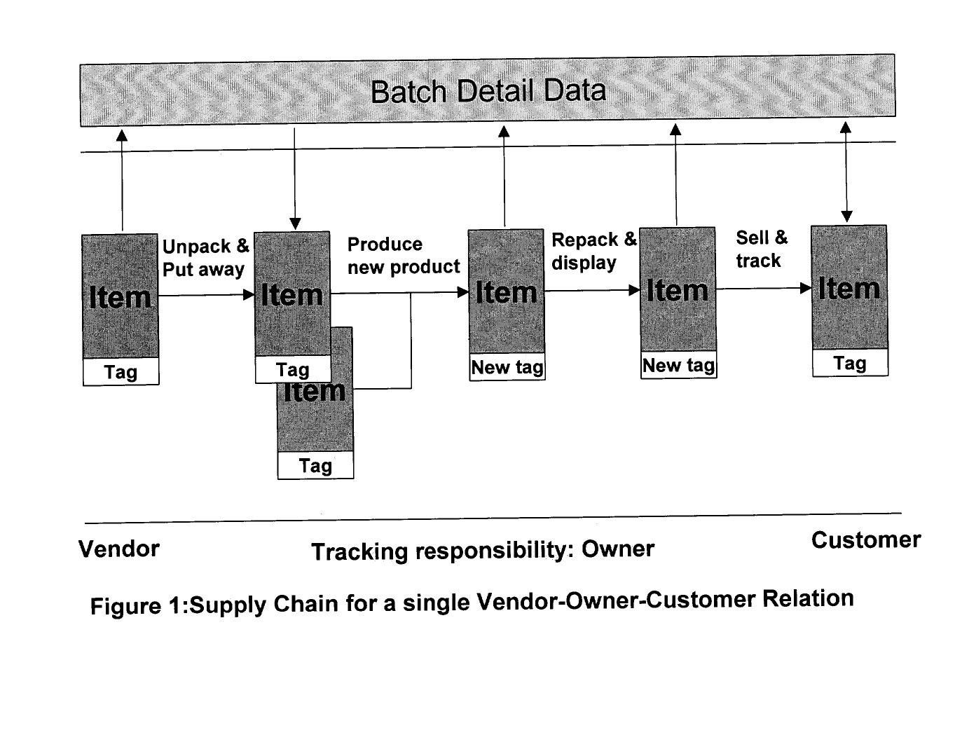

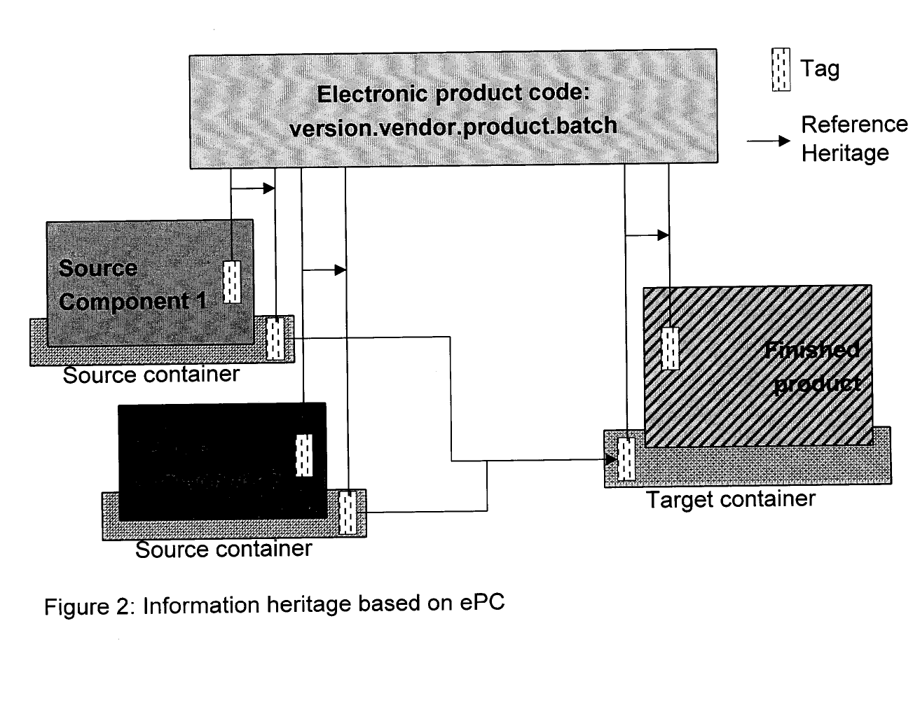

detailed product information for the consumer

loss prevention by tight monitoring every level including transport

cross reference of all related products in case of recalls

logistics for any industry

The method supports the implementation of regulation 2002/178 on food safety of the European Community.

### BACKGROUND OF THE INVENTION

For the purpose of standardization of identifaction of goods in the logistic process international norming institutes have developed identification methods and recommendations, which provide barcode symbology called EAN.UCC-128 and allow coding of various attributes of commercial merchandise.

However, the resulting tags require optical read and a certain quality of print to be recognized by laser technology. As merchandise changes properties or purpose, or is processed and altered, a new code128 identification tag must be produced to continue the tracking. Old properties are lost unless recorded via IT storage methods.

New technologies like RFID (radio frequency identification) in conjunction with the ePC (electronic product code) as promoted by the AutoID-Center in Boston, Mass., allow for license-plate identification of merchandise on product or case level which differs from barcode identification by two principle abilities:

They are readable without line of sight

They allow new coding without changing the tag

The abilities are the base for new automation opportunities in the field of item tracking, to create better loss prevention and knowledge about single items or packs.

The related U.S. patent classifications may not exclusively include:

700/90 SPECIFIC APPLICATION, APPARATUS OR PROCESS

95 Product assembly or manufacturing

112 Having particular work transport control between manufacturing stations

113 Mobile transport

213 Article handling

231 Dispensing or vending

232 Operator or payment initiated

236 Data collection or reporting (e.g., sales, inventory)

### BRIEF SUMMARY OF THE INVENTION

Multi-modal Items Tracking Heritage enables the seamless tracking of goods from raw material to the consumerable package (and consumer) to enable each level of the supply chain to report about

source of product (vendor, transportation, goods receipt, batch, expiry)

transformation of product (unpack, process, repack, shelf-life)

sales of product (customer, goods issue, batch, transportation, expiry)

The innovation of this invention consists of the automated linkage of component information with the final product by using RFID tags and their read/write advantages. All source information is transferred to the next level of production/distribution and intermediate batches are created for full internal quality and source auditing. For easy handling, the source information is preserved via storage of the appropriate reference information on an RFID tag attached to the component container (handling unit). When the goods are altered in kind (e.g.: driven by production order), all source information is linked to a new virtual batch number which then identifies the resulting containers for the finished goods via the corresponding RFID tag. Hence the original component information is inherited by the finished product by linkage to their container as their physical link.

If required, a physical code128 barcode tag may be produced for each virtual batch.

### DETAILED DESCRIPTION OR THE INVENTION

The method of multi-modal items tracking heritage works according the following principle and is only described for one arbitrary vendor-owner-customer relation (the complete chain then consists of a sequence of such relations):

[image]

Description of Steps:

1. All sourcing merchandise subject to tracking is supposed to have an initial code128 tag for receiving, displaying the version-vendor-product-batch specification of the unit's content (the item). The merchandise is received by reading the code128-coded information with the appropriate bar code reader. If required, information systems may utilize Batch Detail Data provided by a specific IT-Layer, either web-hosted or proprietary.

2. After receiving the merchandise is unpacked and put on containers for internal transportation. These containers are identified either by bar code or RFID readable tags. They contain the same information as the merchandise put on it, each kind/batch requires a container of its own to preserve the unique identification.

3. When altering the product or producing a new one, all sourcing tag references are carried over to a newly created batch, resulting in a new tag identification. When RFID tags are used, this step can be performed virtually on the IS-System layer only (presumably the new product properties are also controlled by IT-Systems).

4. Repackaging and combination of merchandise in displays also result in new tags, keeping track of the units involved and referencing again all sourcing information.

5. Finally, during sales, the sold goods carry an code128 bar code label for external processing. The related electronic invoice provides optional details for all items to refer to the batches involved. This serves for customer information in case of recalls by the selling party.

As an important backbone, the Batch Detail Data (BDD) layer is implemented either in a proprietary or web-hosted standard architecture. The data structures are largely predefined by the code128 standard and can be extended according to industry specific purposes. A heritage wizard supports inquiries about related batches in the BDD layer, based on a cross reference of all (real and virtual) batch numbers.

For more ease of use, Multi-modal Items Tracking Heritage is designed for the utilisation of multi-modal readers that can identify barcode and RFID tags with the same device. This simplifies the process discipline and handling of steps 2, 3 and 4 of the above. By process code, distinguishing the basic business process of unpacking, production and repacking, the dual modal reader supports the following reading sequences:

Unpacking:

1. Read original code128 bar code times no. of units with identical batch

2. Initialize container (e.g. tray, pallet, case) by copying code and no. of units to RFID fixed to the container

As a result, both the container and each unit have the link to its source information

Production:

1. Read each component container involved and provide (measure) required component quantity

2. Create new batch by linkage of all component IDs and quantities ((product master to be determined manually or by production order details)

3. Write new batch RFID to every receiving container of the new product (no. of container to be determined manually or by production order details)

As a result, the proportions of sourcing batches are available at each production step.

Repacking:

1. Read the RFID codes from each container involved and provide (measure) required finished product quantity

2. Create new batch by linkage of all batch IDs of finished products

3. Print code128 barcode label and attach

As a result, all batch links may be provided upon sales for customer information.

The detailed linkage of the source information via the containers is shown in the following figure:

[image]

The source object (e.g.item-pack), as well as its container, have been identically coded by barcode (code 128), RFID tag (with the same structure as code 128) or other appropriate means and contain reference links to all their source attributes. The target container finally transfers its reference to the finished products when they are tagged (either by RFID tags or code 128 barcode printed tags).

Advantages and applicability:

Multi-modal items Tracking Heritage is applicable for all transport and production tracking in the industrial logistics if the merchandise involved allows the application of barcode or RFID tags. Particular advantage is for all industries involving batches with individual properties for support of quality assurance or legal requirements. RFID provides particular ease-of-use and reduces the burden of additional manual work or handling of printed labels. They provide the base for little errors and high degree of automation.

The link to the BDD-layer allows the implementation of inventory management, loss prevention measures, CRM-analysis and production control.

Examples are the automotive and chemical industries as well as CPG and retail.

The stepwise introduction of multi-modal items Tracking Heritage allows each participant to control processes within his own accountability, whereas the full implementation will allow the seamless proof of origin from raw material to final consumers for everybody in the supply chain.

1. The process-automated linkage of container IDs with their corresponding merchandise IDs as a new mechanism for a safe and automated transfer of information from source to finished product

2. The use of multi-modal (e.g. barcode and RFID) readers to support the automation via process codes to address various specific types of processes (e.g. unpacking, production, repacking) and batch properties (e.g. quantity, shelf-life, number), yielding the heritage algorithms

3. The generation of new virtual batches according to properties comparison when reading the source batches

4. The linkage of virtual batch properties and their batch detail update in the corresponding BDD layer (Batch Detail Data).

5. The heritage wizard in the BDD layer for cross-ref of all related batches
